(19) United States
(12) Patent Application Publication
(10) Pub. No.: US 2018/0302891 A1
(43) Pub. Date: Oct. 18, 2018

(54) ENABLING CARRIER AGGREGATION RECEIVER CHAINS OF A USER EQUIPMENT

(71) Applicant: QUALCOMM Incorporated, San Diego, CA (US)

(72) Inventors: Suresh Kumar Bitra, Mangalagiri (IN); Arun Kumar Sharma Tandra, Hyderabad (IN); Ashwin Kumar Donthula, Hyderabad (IN)

(21) Appl. No.: 15/488,471

(22) Filed: Apr. 15, 2017

(51) Int. Cl. H04W 72/04; H04W 16/10; H04W 64/00; H04W 4/22

(52) U.S. Cl. CPC H04W 72/048; H04W 4/22; H04W 64/00; H04W 16/10

(57) ABSTRACT

Disclosed are techniques for enabling carrier aggregation receivers of a user equipment. In an aspect, the user equipment receives positioning assistance data from a location server, the positioning assistance data including information to assist the user equipment to perform a plurality of inter-frequency positioning measurements corresponding to a plurality of inter-frequency base stations, determines a carrier aggregation receiver chain configuration supported by the user equipment, the carrier aggregation receiver chain configuration having a number of carrier aggregation receiver chains corresponding to the plurality of inter-frequency base stations, and enables the number of carrier aggregation receiver chains to perform the plurality of inter-frequency positioning measurements.

### BACKGROUND OF THE DISCLOSURE

### 1. Field of the Disclosure

Aspects of the disclosure relate to enabling carrier aggregation receiver chains of a user equipment.

### 2. Description of the Related Art

Wireless communication systems have developed through various generations, including a first-generation analog wireless phone service (1G), a second-generation (2G) digital wireless phone service (including interim 2.5G and 2.75G networks) and third-generation (3G) and fourth-generation (4G) high speed data/Internet-capable wireless services. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile Communications (GSM) variation of TDMA, and newer hybrid digital communication systems using both TDMA and CDMA technologies.

More recently, Long Term Evolution (LTE) has been developed as a wireless communications protocol for wireless communication of high-speed data for mobile phones and other data terminals. LTE is based on GSM, and includes contributions from various GSM-related protocols such as Enhanced Data rates for GSM Evolution (EDGE), and Universal Mobile Telecommunications System (UMTS) protocols such as High-Speed Packet Access (HSPA).

In wireless communication systems, wireless terminals, referred to as User Equipments (UEs) in LTE, communicate wirelessly with base stations of the wireless communication system. In the downlink, from the base station to the UE, the UE may receive signals in a single frequency band associated with a single radio-frequency (RF) carrier. In order to improve capacity (e.g., in terms of downlink bitrate), the concept of carrier aggregation (CA) has been introduced in 3rd Generation Partnership Program (3GPP) standards. Using CA, the UE may simultaneously receive a plurality of RF carriers. These RF carriers are normally referred to as component carriers (CCs). On each CC, there is a modulated information signal, e.g., an Orthogonal Frequency Division Multiple Access (OFDMA) signal or a CDMA signal, carrying payload data and/or control information. The CCs may be located within the same operating frequency band, in which case the CA is referred to as intra-band CA. Alternatively, the CCs may be located within different operating frequency bands, in which case the CA is referred to as inter-frequency CA.

For intra-frequency CA, the plurality of CCs may be located contiguously (in frequency), in which case the CA is referred to as contiguous CA, or may be non-contiguously located (in frequency) with frequency gaps in between, in which case the CA is referred to as non-contiguous CA. In an intra-frequency system, all the CCs belong to the same radio access technology (RAT), wherein in an inter-frequency system, the CCs may belong to different RATs. For example, in such systems, one CC may belong to LTE frequency division duplex (FDD) and another one to LTE time division duplex (TDD). As another example, the CCs may belong to Universal Terrestrial Radio Access Network (UTRAN) FDD and evolved UTRAN (E-UTRAN) FDD.

In one scenario, the UE may be allocated a primary CC (PCC) associated with a primary cell (PCell) of the cellular communications network. When an increase in downlink capacity is desired, for whatever reason, the UE may additionally be allocated one or more secondary CCs (SCCs) associated with respective secondary cells (SCells).

### SUMMARY

The following presents a simplified summary relating to one or more aspects disclosed herein. As such, the following summary should not be considered an extensive overview relating to all contemplated aspects, nor should the following summary be regarded to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method for enabling carrier aggregation receivers of a user equipment includes receiving, at the user equipment, positioning assistance data from a location server, the positioning assistance data including information to assist the user equipment to perform a plurality of inter-frequency positioning measurements corresponding to a plurality of inter-frequency base stations, determining, by the user equipment, a carrier aggregation receiver chain configuration supported by the user equipment, the carrier aggregation receiver chain configuration having a number of carrier aggregation receiver chains corresponding to the plurality of inter-frequency base stations; and enabling, by the user equipment, the number of carrier aggregation receiver chains to perform the plurality of inter-frequency positioning measurements.

In an aspect, an apparatus for enabling carrier aggregation receivers of a user equipment includes a transceiver configured to receive positioning assistance data from a location server, the positioning assistance data including information to assist the user equipment to perform a plurality of inter-frequency positioning measurements corresponding to a plurality of inter-frequency base stations, and at least one processor configured to: determine a carrier aggregation receiver chain configuration supported by the user equipment, the carrier aggregation receiver chain configuration having a number of carrier aggregation receiver chains corresponding to the plurality of inter-frequency base stations, and enable the number of carrier aggregation receiver chains to perform the plurality of inter-frequency positioning measurements.

In an aspect, a non-transitory computer-readable medium storing computer-executable instructions for enabling carrier aggregation receivers of a user equipment includes computer-executable instructions including at least one instruction instructing a user equipment to receive positioning assistance data from a location server, the positioning assistance data including information to assist the user equipment to perform a plurality of inter-frequency positioning measurements corresponding to a plurality of inter-frequency base stations, at least one instruction instructing the user equipment to determine a carrier aggregation receiver chain configuration supported by the user equipment, the carrier aggregation receiver chain configuration having a number of carrier aggregation receiver chains corresponding to the plurality of inter-frequency base stations, and at least one instruction instructing the user equipment to enable the number of carrier aggregation receiver chains to perform the plurality of inter-frequency positioning measurements.

In an aspect, an apparatus for enabling carrier aggregation receivers of a user equipment includes means for receiving positioning assistance data from a location server, the positioning assistance data including information to assist the user equipment to perform a plurality of inter-frequency positioning measurements corresponding to a plurality of inter-frequency base stations, means for determining a carrier aggregation receiver chain configuration supported by the user equipment, the carrier aggregation receiver chain configuration having a number of carrier aggregation receiver chains corresponding to the plurality of inter-frequency base stations, and means for enabling the number of carrier aggregation receiver chains to perform the plurality of inter-frequency positioning measurements.

Other objects and advantages associated with the aspects disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an aspect of the disclosure.

FIGS. 2A and 2B illustrate high-level system architectures of wireless communications systems in accordance with various aspects of the disclosure.

FIG. 3 is a functional block diagram of a user equipment (UE) according to at least one aspect of the disclosure.

FIG. 4 illustrates an LTE Positioning Protocol (LPP) call flow between a UE and the location server for performing Observed Time-Difference of Arrival (OTDOA) positioning measurements.

FIG. 5 illustrates an LTE LPP call flow between a UE and the location server for performing OTDOA positioning measurements according to an aspect of the disclosure.

FIG. 6 illustrates an LTE LPP call flow between a UE and the location server for performing OTDOA positioning measurements according to an aspect of the disclosure.

FIG. 7 illustrates an exemplary flow for UE-initiated carrier aggregation (CA) receiver enablement according to at least one aspect of the disclosure.

FIG. 8 illustrates an exemplary flow for enabling carrier aggregation receivers of a user equipment.

FIG. 9 is a simplified block diagram of several sample aspects of an apparatus configured to support communication as taught herein.

### DETAILED DESCRIPTION

Disclosed are techniques for enabling carrier aggregation receivers of a user equipment. In an aspect, the user equipment receives positioning assistance data from a location server, the positioning assistance data including information to assist the user equipment to perform a plurality of inter-frequency positioning measurements corresponding to a plurality of inter-frequency base stations, determines a carrier aggregation receiver chain configuration supported by the user equipment, the carrier aggregation receiver chain configuration having a number of carrier aggregation receiver chains corresponding to the plurality of inter-frequency base stations, and enables the number of carrier aggregation receiver chains to perform the plurality of inter-frequency positioning measurements.

These and other aspects of the disclosure are described in the following description and related drawings directed to specific aspects of the disclosure. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can, in some implementations, be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT,” a “wireless device,” a “subscriber device,” a “subscriber terminal,” a “subscriber station,” a “user terminal” or UT, a “mobile terminal,” a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on the Institute of Electrical and Electronics Engineers (IEEE) 802.11 standard, etc.) and so on. UEs can be embodied by any of a number of types of devices including but not limited to personal computer (PC) cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

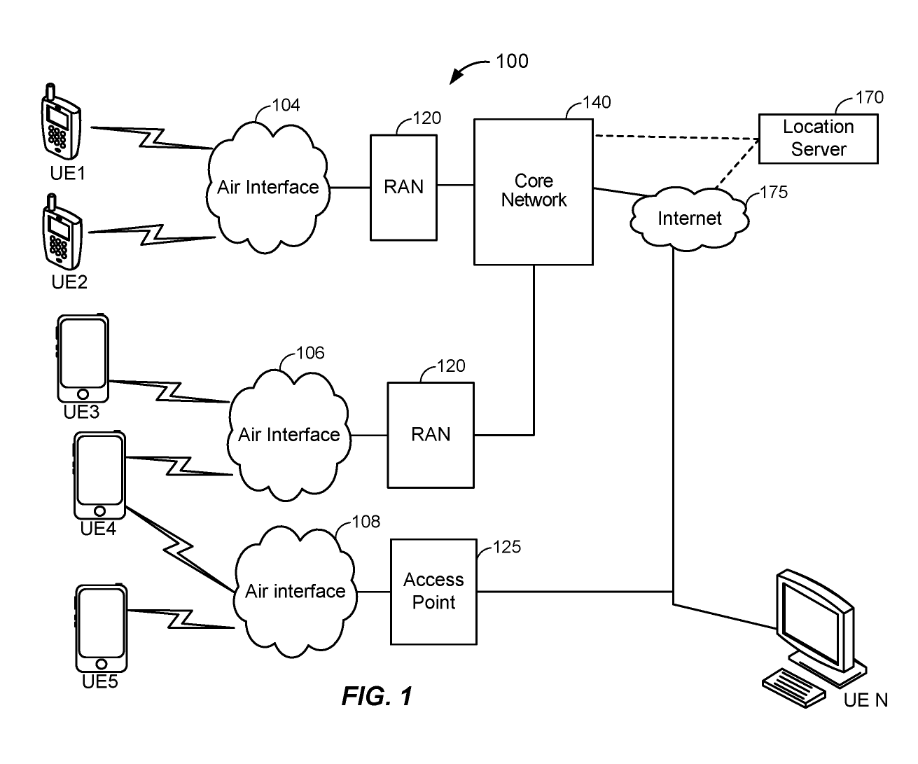

FIG. 1 illustrates a high-level system architecture of a wireless communications system 100 in accordance with an aspect of the disclosure. The wireless communications system 100 contains UE 1 to UE N. The UE 1 to UE N can include cellular telephones, personal digital assistant (PDAs), pagers, tablet computers, a laptop computer, a desktop computer, and so on. For example, in FIG. 1, UE 1 and UE 2 are illustrated as cellular calling phones, UE 3, UE 4, and UE 5 are illustrated as cellular touchscreen phones or smart phones, and UE N is illustrated as a desktop computer or PC.

Referring to FIG. 1, UE 1 to UE N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., Code Division Multiple Access (CDMA), Evolution Data-Optimized (EV-DO), enhanced High Rate Packet Data (eHRPD), GSM, Enhanced Data Rates for GSM Evolution (EDGE), Wideband CDMA (W-CDMA), LTE, etc.), while the air interface 108 can comply with a wireless Internet protocol (IP) (e.g., IEEE 802.11). The RAN 120 includes a plurality of access points that serve UEs over air interfaces, such as the air interfaces 104 and 106. The access points in the RAN 120 can be referred to as “access nodes” or “ANs,” “access points” or “APs,” “base stations” or “BSs,” “Node Bs,” “eNode Bs,” “eNBs,” and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UE 1 UE N via the core network 140. Also shown in FIG. 1 is an access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a location server 170 is shown as connected to the Internet 175, the core network 140, or both. The location server 170 can be implemented as a plurality of structurally separate servers, or alternately may correspond to a single server. As will be described below in more detail, the location server 170 is configured to support one or more location services for UEs that can connect to the location server 170 via the core network 140 and/or the Internet 175.

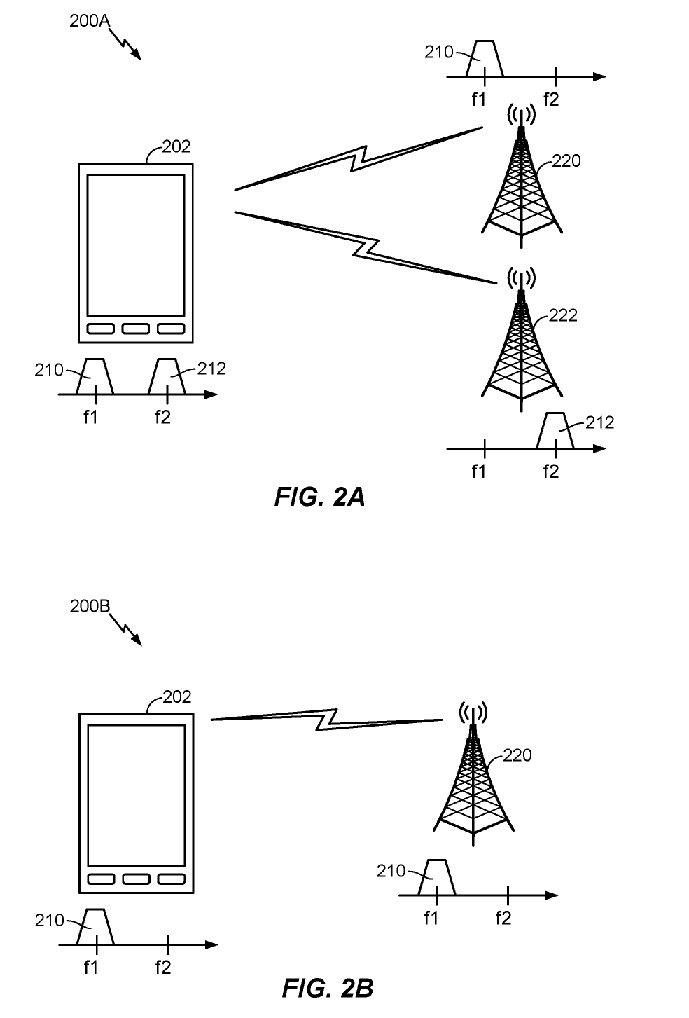

FIG. 2A illustrates a high-level system architecture of a wireless communications system 200A in accordance with an aspect of the disclosure. In FIG. 2A, a UE 202, which may correspond to one of UEs 1-4 in FIG. 1, is in wireless communication with a cellular communication system illustrated as including two base stations, first base station 220 and second base station 222. The first base station 220 and second base station 222 may be base stations in RAN 120. The first base station 220 and second base station 222 may be macro base stations, such as eNodeBs of an evolved Universal Terrestrial Radio Access Network (eUTRAN), micro, pico, or femto base stations, or any other kind of current or future base stations.

In carrier aggregation (CA) mode, a radio-receiver circuit (described further below) of the UE 202 is arranged to receive a plurality of (downlink) component carriers (CCs), which may be contiguous or non-contiguous. Normally, one of the CCs is a primary CC (PCC) of a primary cell (PCell), and any other CCs are secondary CCs (SCCs) of secondary cells (SCells). In FIG. 2A, the plurality of CCs comprises a first CC 210 at a first (RF) carrier frequency f1 and a second CC 212, which is separate from the first CC 210, at a second (RF) carrier frequency f2. The first CC 210 may be the PCC, and the second CC 212 may be an SCC, or vice versa. In general, as there may be more than one SCell, there may be more than the two CCs illustrated in FIG. 2A.

In FIG. 2A, the first CC 210 is illustrated as transmitted from the first base station 220, and the second CC 212 is illustrated as transmitted from the second base station 222, but in general, they may also be transmitted from the same base station. Furthermore, in FIG. 2A, the first CC 210 and second CC 212 are illustrated as non-contiguous (or non-adjacent) CCs having a frequency gap (in the illustrated example, the portion of the frequency band between the non-contiguous/non-adjacent CCs) between them, but in other aspects, they may be contiguous (or adjacent) CCs.

FIG. 2B illustrates a high-level system architecture of a wireless communications system 200B in accordance with an aspect of the disclosure. In FIG. 2B, the UE 202 is in wireless communication with the cellular communication system in a non-CA mode. In the non-CA mode illustrated in FIG. 2B, the radio receiver circuit of the UE 202 is arranged to receive the first CC 210 as a single CC from the first base station 220. However, this is merely an example, and the radio receiver circuit of the UE 202 may be arranged to receive some other CC (such as but not limited to the second CC 212 in FIG. 2A) and/or from some other base station (such as but not limited to the second base station 222).

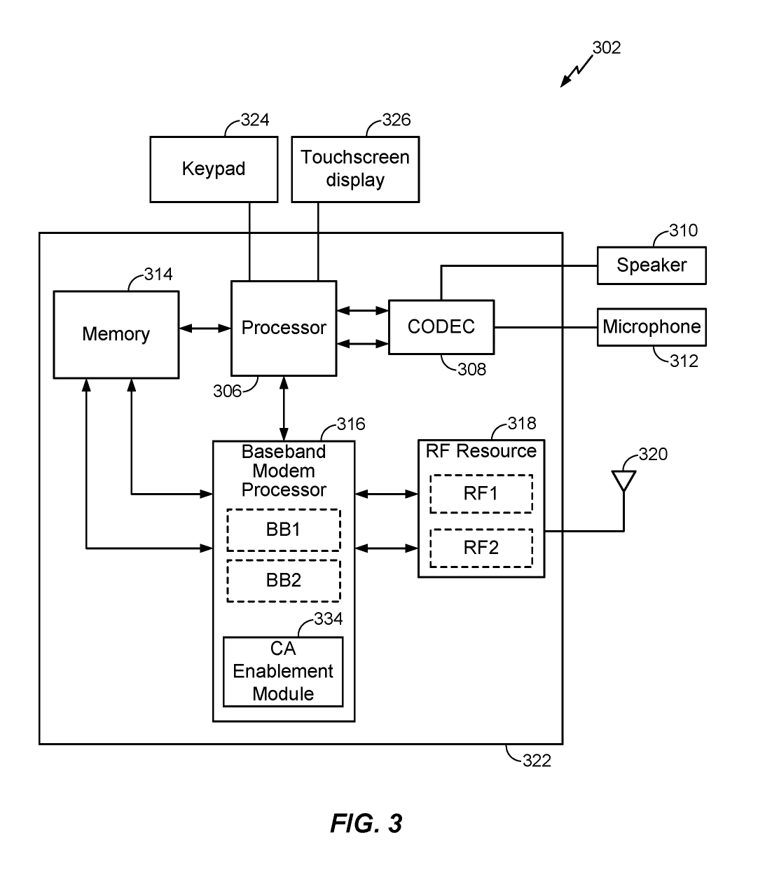

FIG. 3 is a functional block diagram of the UE 202 according to at least one aspect of the disclosure. UE 202 may include at least one controller, such as a processor 306, which may be coupled to a coder/decoder (CODEC) 308. The CODEC 308 may in turn be coupled to a speaker 310 and a microphone 312. The processor 306 may also be coupled to at least one memory, for example, memory 314. Memory 314 may be a non-transitory tangible computer-readable storage medium that stores processor-executable instructions. The memory 314 may store user application software and executable instructions instructing the processor 306 to perform operations described herein.

The processor 306 and memory 314 may each be coupled to at least one baseband modem processor, such as baseband modem processor 316. A baseband-RF resource chain may include baseband modem processor 316, which may perform baseband/modem functions for communications on at least one CC (e.g., first CC 210 or second CC 212), and may further include one or more amplifiers and radios, referred to generally herein as RF resource 318. RF resource 318 may perform transmit/receive functions for at least one CC. In an aspect, RF resource 318 may include separate transmit and receive circuitry, or may include a transceiver that combines transmitter and receiver functions. The RF resource 318 may be coupled to a wireless antenna 320. The baseband modem processor 316 may further include a CA enablement module 334 configured to perform the CA enablement functionality described herein.

In one aspect, the UE 202 may have a common baseband-RF resource chain (i.e., a single baseband modem processor, such as baseband modem processor 316 and a single RF resource, such as RF resource 318). In another aspect, the UE 202 may have separate baseband-RF resource chains that include physically or logically separate RF resources (illustrated as RF1 and RF2), each of which may be coupled to a common baseband modem processor, such as baseband modem processor 316 (i.e., a single device that performs baseband/modem functions for the UE 202). Alternatively, the UE 202 may have separate baseband-RF resource chains that also include physically or logically separate baseband modem processors (illustrated as BB1 and BB2). In an aspect, each separate baseband-RF resource chain, i.e., a separate RF resource linked to a separate baseband modem processor, may be configured to communicate on a separate CC.

The memory 314 of the UE 202 may further store an operating system (OS) and user application software. In a particular aspect, the processor 306, memory 314, baseband modem processor 316 (including, in some aspects, BB1 and BB2), and RF resource 318 (including, in some aspects, RF1 and RF2) may be included in a system-on-chip (SoC) device 322. Further, various input and output devices may be coupled to components of the SoC device 322, such as interfaces or controllers. Example user input components suitable for use in the UE 202 may include, but are not limited to, a keypad 324 and a touchscreen display 326.

In a CA system, i.e., a multi-carrier system, the UE 202 may simultaneously receive and/or transmit data over more than one CC (e.g., first CC 210 and/or second CC 212). The multi-carrier concept is used in both HSPA and LTE. In CA mode, the primary CC carries all common and UE-specific control channels, while the secondary CC may contain only signaling information and signals. Signaling information or signals that are UE-specific may not be present in the secondary CC, since both primary uplink and downlink CCs are typically UE-specific. This means that different UEs in a cell may have different primary downlink CCs.

The simultaneous transmission and/or reception over the CCs enables the UE 202 to increase its data transmission and reception rates. For instance, an aggregation of two 20 MHz carriers in an LTE multi-carrier system would theoretically lead to a doubled data rate compared to that attained by a single 20 MHz carrier.

The UE 202 may be able to perform measurements on a secondary CC, and likewise on other frequency carriers, without utilizing measurement gaps or compressed mode, where the UE 202 comprises more than one transceiver (e.g., RF resources RF1 and RF2). Compressed mode can be used to make measurements on another frequency (inter-frequency) or on a different radio access technology. Using compressed mode, the UE 202 ceases transmission and reception for a short time and performs measurements on the other frequency or RAT in that time. Measurement gaps define time periods when no uplink or downlink transmissions will be scheduled. In LTE, for example, using measurement gaps, the UE 202 will experience a 6 ms blackout every 40 ms for the duration of the inter-frequency measurements. This is a 15% short-term drop in throughput. Measurement gaps are overhead for the network, and therefore, network carriers prefer the UE 202 to utilize Inter-Frequency Observed Time Difference of Arrival (IF-OTDOA) using CA instead of measurement gaps.

However, the capability to perform measurements on a secondary CC, and likewise on other frequency carriers, without utilizing measurement gaps can either be optional or mandatory in the UE 202. In addition, this capability may be mandatory for a certain number of secondary CCs and optional beyond that number. For example, if the UE 202 were configured to support up to four CCs in total, it may be mandatory for the UE 202 to measure on one secondary CC (i.e., on the second carrier) without measurement gaps but optional to measure on the remaining secondary CCs (i.e., on the third and fourth carriers). This means that where the UE 202 is configured to support up to two CCs in total, the measurements on the secondary CC, which is the only secondary carrier, may be mandatory. As this measurement capability is optional, the UE 202 may separately signal this capability to the network in addition to its carrier aggregation capability signaling.

U.S. cellular carriers have mandated IF-OTDOA for emergency calls (e.g., e911 calls) to cover locations where they may have isolated eNode Bs on one frequency, but may have more eNode Bs on one or more other frequencies. In present implementations, the UE (e.g., UE 202) cannot make use of its CA receiver chains for IF-OTDOA measurements, even though it has the capability, unless it is on a CA call. If the UE 202 is not in CA mode, inter-frequency measurements utilize measurement gaps for the current serving cell. As noted above, measurement gaps define time periods when no uplink or downlink transmissions will be scheduled. For example, in LTE, using measurement gaps, the UE 202 will experience a 6 ms blackout every 40 ms for the duration of the inter-frequency measurements. As noted above, measurement gaps are overhead for the network, and therefore, network carriers prefer the UE 202 to utilize IF-OTDOA using CA instead of measurement gaps.

Presently, the network controls the CA enablement or disablement for a UE (e.g., UE 202) depending on the download/upload speed requirements of the UE 202. The network enables CA for the UE 202 based on the number of CCs the UE 202 is capable of receiving and the UE 202's throughput requirements. Currently, the network does not consider OTDOA session activity by the UE 202 to enable CA mode at the UE 202 during, for example, e911 calls, resulting in no usage of CA receivers for OTDOA measurements for such calls. This can adversely affect the OTDOA performance and result in less efficient usage of the UE 202's CA capabilities.

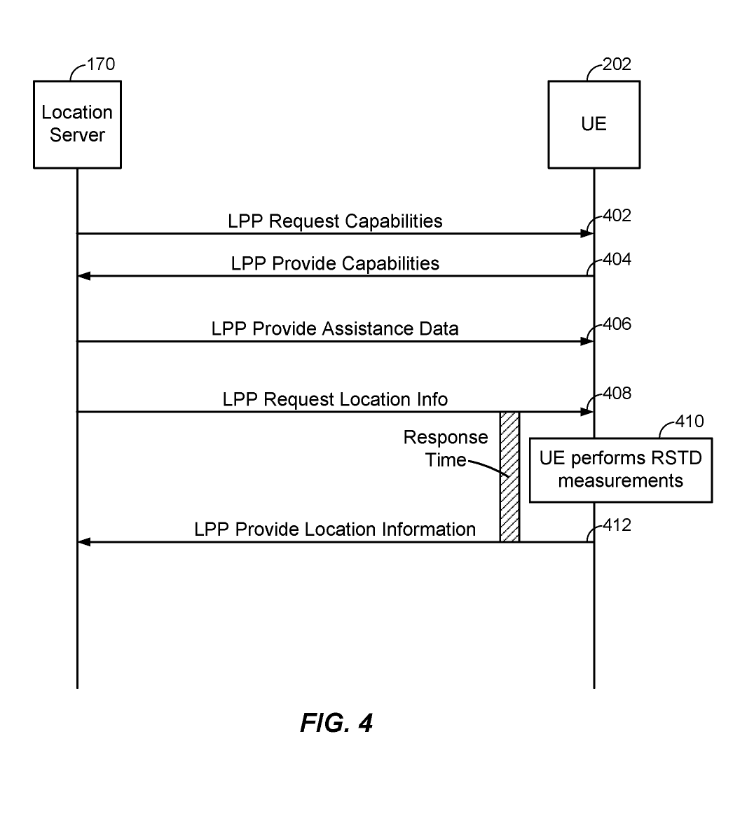

FIG. 4 illustrates an LPP call flow between the UE 202 and the location server 170 for performing OTDOA positioning measurements. At 402, the location server 170 sends an LPP capabilities request to the UE 202. At 404, the UE 202 responds with its LPP capabilities. At 406, the location server 170 sends assistance data for LPP positioning measurements to the UE 202. At 408, the location server 170 sends a request for location information to the UE 202. At 410, the UE 202 performs Reference Signal Time Difference (RSTD) and/or OTDOA measurements. At 412, the UE 202 provides its location information to the location server 170, such as the RSTD and/or OTDOA measurements. Note that the time between the request for location information at 408 and the response at 412 is the “response time.”

The present disclosure provides a mechanism to enable CA receivers for OTDOA measurements, particularly during an e911 call. Two solutions are presented, one where CA receiver enablement is network-initiated, and a second where the CA receiver enablement is performed by the UE 202. Referring to the first solution, a mechanism of the present disclosure augments the LPP procedure illustrated in FIG. 4. During an e911 call, the network initiates a Network-Initiated Location Request (NILR) to the UE 202 using the LTE LPP, either on the Control Plane or the User Plane (i.e., Secure User Plane Location (SUPL)). More specifically, the location server 170 (e.g., Serving Mobile Location Center (SMLC)/SUPL Location Platform (SLP) in LTE) initiates the NILR using LPP.

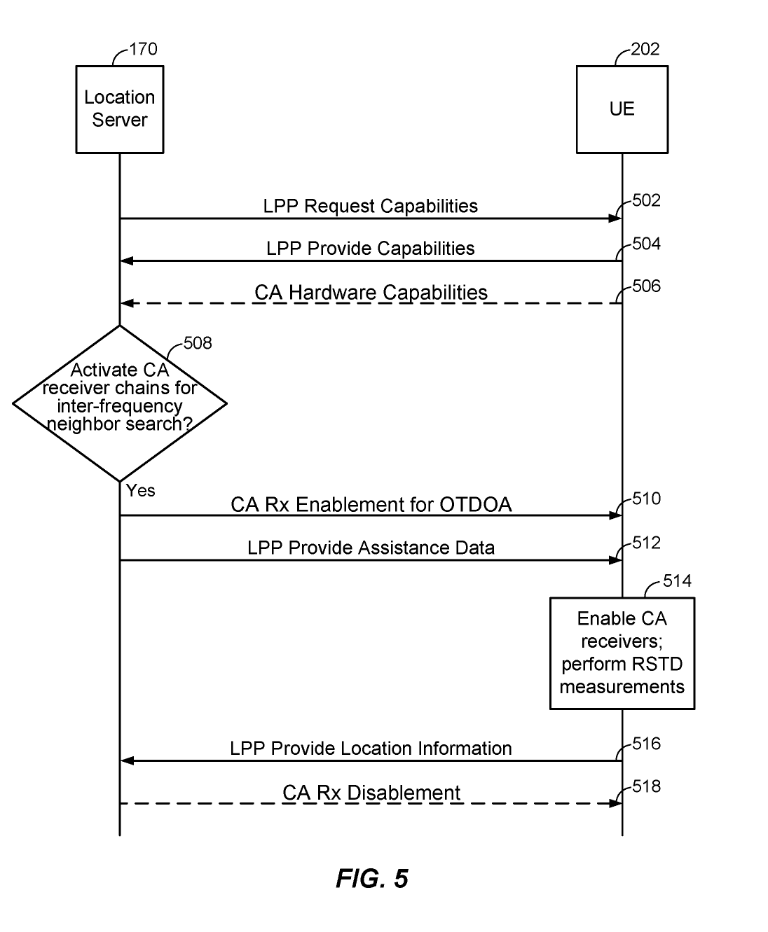

Specifically, as shown in FIG. 5, during the OTDOA session, the UE 202 and the location server 170 exchange capabilities using “LPP Request Capabilities” and “LPP Provide Capabilities” messages at 502 and 504, respectively. The UE 202 can advertise its CA hardware capabilities to the location server 170 in the “LPP Provide Capabilities” message, or in a separate message (illustrated as an optional “CA Hardware Capabilities” message at 506). Upon receiving the UE 202's capabilities, the location server 170 decides, at 508, whether or not to activate CA receiver chains of the UE 202 for inter-frequency neighbor search based on base station (e.g., eNode B) deployment at the location of the UE 202. If the location server 170 finds a sufficient number of inter-frequency base stations deployed near the UE 202, then at 510, the location server 170 can send a “CA Rx Enablement for OTDOA” command to the UE 202, and at 512, the assistance data. Alternatively, the location server 170 can send both the “CA Rx Enablement for OTDOA” command and the assistance data in the same message.

The “CA Rx Enablement for OTDOA” information element (IE) can convey the following information to the UE 202: (1) enablement or disablement of CA receivers, (2) which CA mode to use, e.g., two-receiver downlink carrier aggregation (2DLCA), three-receiver downlink carrier aggregation (3DLCA), etc. (which may be based on the assistance data from the location server 170), and (3) whether the CA command from the location server 170 should override the network CA disablement/enablement during e911 calls. Note that in 2DLCA, two receivers, i.e., the primary receiver and a secondary CA receiver, will be used. In 3DLCA, three receivers, i.e., the primary receiver and two secondary CA receivers, will be used.

Upon receiving the above-described CA enablement command, the UE 202, at 514, can enable the appropriate CA receivers and perform the RSTD/OTDOA measurements. At 516, the UE 202 can report the measurements to the location server 170. Although not illustrated in FIG. 5, the location server 170 may send a request for location information to the UE 202 as at 408 of FIG. 4. The UE 202 can optionally deactivate the enabled CA receiver chains upon session completion/termination voluntarily, or the location server 170 can explicitly send a CA disablement command, as illustrated in FIG. 5 as illustrated at 518. In one particular implementation, the UE 202 can deactivate the number of enabled CA receiver chains after responding to the location request, such as an NILR and/or a location request that is received from the location server 170 in response to the UE 202 initiating an emergency call, with the plurality of inter-frequency positioning measurements. Note that if the UE 202 is already using one or more CA receiver chains for one or more data sessions, and in between uses them for positioning measurements purposes, then the UE 202 need not deactivate the in-use CA receiver chains after performing the positioning measurements.

In another aspect of the network-initiated solution proposed herein, the location server 170 may involve the serving base station, for example, first base station 220 of FIGS. 2A and 2B. Similar to the solution described above with reference to FIG. 5, during an e911 call, the network initiates an NILR to the UE 202 using LPP either on the Control Plane or the User Plane (e.g., SUPL). More specifically, the location server 170 may initiate the NILR using LPP.

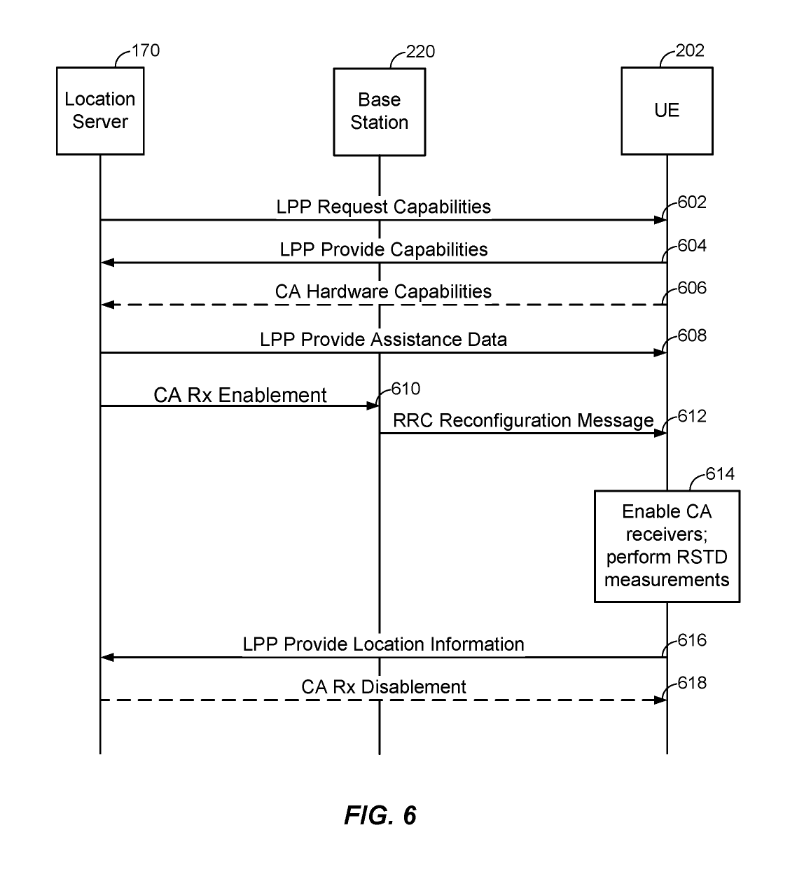

Referring to FIG. 6, as in FIG. 5, during the OTDOA session, the UE 202 and the location server 170 exchange capabilities using “LPP Request Capabilities” and “LPP Provide Capabilities messages at 602 and 604, respectively. The UE 202 can advertise its CA hardware capabilities to the location server 170 in the “LPP Provide Capabilities” message at 604, or in a separate message (illustrated as an optional “CA Hardware Capabilities” message at 606). Although not illustrated in FIG. 6, as at 508 of FIG. 5, upon receiving the UE 202's CA capabilities, the location server 170 decides whether or not the UE 202 would benefit from utilizing CA receiver chains for inter-frequency neighbor search based on the base station (e.g., eNode B) deployment at the location of the UE 202 and the assistance data to be sent.

At 608, the location server 170 sends the assistance data to the UE 202. Simultaneously, at 610, the location server 170 can send a message to the serving base station (for example, first base station 220 of FIGS. 2A and 2B) to enable CA for the UE 202. The location server 170 can use the LPPa protocol to convey this message to the serving base station. Upon receiving the request from the location server 170, the serving base station can, at 612, enable CA for the UE 202 using a “Radio Resource Control (RRC) Reconfiguration Message” to modify the RRC connection. More specifically, the serving base station may use the RRC Reconfiguration Message to instruct the UE 202 to add, modify, or release SCells.

Upon receiving the above-described CA enablement command, the UE 202, at 614, can enable the appropriate CA receivers and perform the RSTD/OTDOA measurements, as at 514 of FIG. 5. At 616, the UE 202 can report the measurements to the location server 170. Although not illustrated in FIG. 6, the location server 170 may send a request for location information to the UE 202 as at 408 of FIG. 4. Upon completion of the OTDOA session, the location server 170 or the serving base station can optionally deactivate CA for the UE 202, as illustrated in FIG. 6 at 618.

In the UE-initiated solution described herein, the location server 170 can send multi-frequency assistance data to the UE 202. In an aspect, the location server 170 may send multi-frequency assistance data to the UE 202 depending on whether or not the UE 202 would benefit from utilizing CA receiver chains for inter-frequency neighbor search based on the base station (e.g., eNode B) deployment at the location of the UE 202 and the assistance data to be sent, similar to the decision at 508 of FIG. 5. The UE 202, upon obtaining the additional inter-frequency assistance data may, if a CA receiver chain is available, enable the CA receiver chain and search the additional frequencies as provided for in the assistance data from the location server 170.

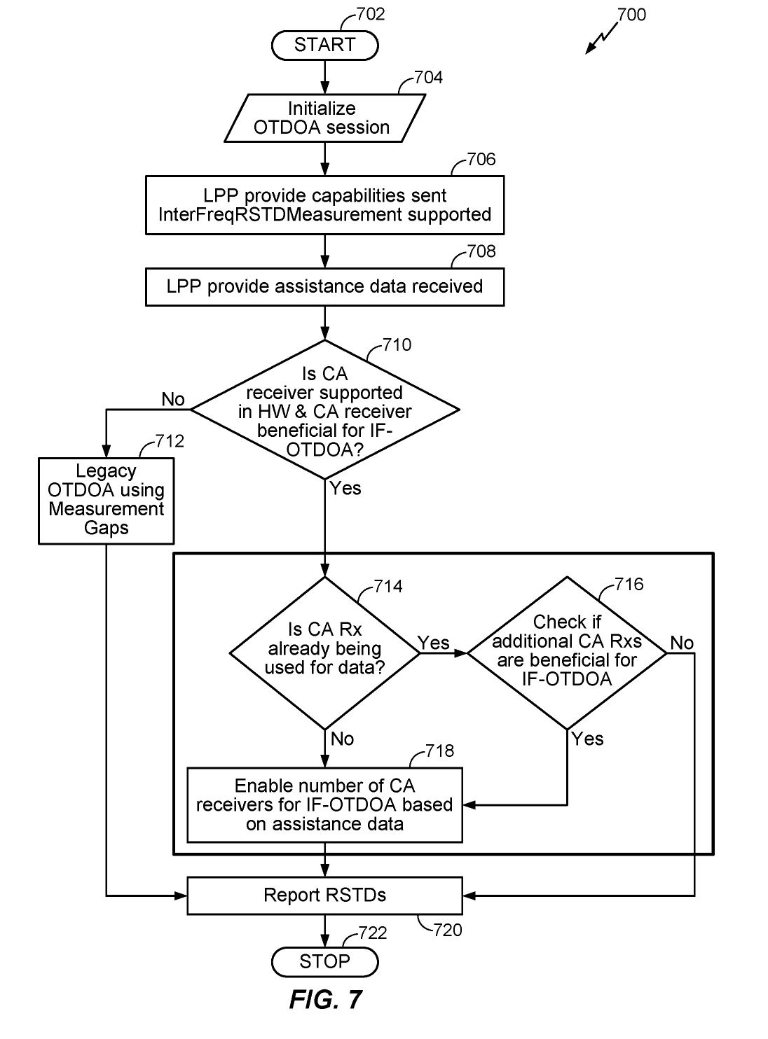

FIG. 7 illustrates an exemplary flow 700 for UE-initiated CA receiver enablement according to at least one aspect of the disclosure. The flow 700 may be performed by the UE 202. More specifically, the flow 700 may be performed by the processor 306 executing the CA enablement module 334 (where the CA enablement module 334 is a software module) and thereby causing various components of the UE 202 to perform the various operations illustrated in FIG. 7. For simplicity, however, FIG. 7 will be described as being performed by the UE 202.

The flow 700 begins at 702. At 704, the UE 202 initializes an OTDOA session with the location server 170. The OTDOA session may be initiated based on the UE 202 initiating an emergency call (e.g., an e911 call) and in response, receiving a location request from the location server 170, for example an NILR, or receiving an LPP Request Capabilities message from the location server 170, as at 502 of FIG. 5. Alternatively, an application resident on the UE 202 (e.g., a location-aware application, such as a mapping application) may initiate the location request (referred to as Mobile-Originated Location Request (MOLR)).

At 706, the UE 202 responds with an LPP Provide Capabilities message, as at 504 of FIG. 5, as well as an indication of whether or not the UE 202 is capable of performing inter-frequency (IF) OTDOA (or RSTD) measurements, such as the CA Hardware Capabilities message transmitted at 506 of FIG. 5. In an aspect, the UE 202 may be configured to support CA. Note that in the LPP Provide Capabilities message, the UE 202 simply indicates whether or not it is capable of performing IF-OTDOA measurements. It does not convey the IF-OTDOA mode explicitly, i.e., measurement gap (MG) mode or CA mode.

At 708, the UE 202 receives assistance data from the location server 170 in the form of an LPP Provide Assistance Data message, as at 512 of FIG. 5. The assistance data may include information for measuring signals from a plurality of inter-frequency base stations (e.g., eNode Bs). In an aspect, the assistance data may include information for all base stations near enough to the UE 202 that it can receive positioning reference signals from the base stations, or the closest N (e.g., 10) base stations to the UE 202, regardless of what frequency the base stations utilize for those positioning reference signals. Alternatively, as noted above, the location server 170 may have included the inter-frequency information based on determining that the UE 202 is configured to support CA and that there are inter-frequency base stations at the location of the UE 202, such that the UE 202 would benefit from utilizing CA. More specifically, the UE 202 would likely benefit from utilizing CA when there are not enough base stations near the UE 202 on the same frequency to perform enough positioning measurements to accurately locate the UE 202. Typically, the UE 202 measures positioning reference signals from at least three base stations to be accurately located.

At 710, the UE 202 determines whether or not it supports a CA mode (as opposed to an MG mode) and whether or not CA would be beneficial for IF-OTDOA measurements (e.g., whether are not there are enough base stations near the UE 202 on the same frequency to perform enough positioning measurements to accurately locate the UE 202). If the UE 202 does not support a CA mode, then at 712, the UE 202 utilizes measurement gaps to perform the IF-OTDOA measurements. However, although not illustrated in FIG. 7, if IF-OTDOA is not called for because, for example, there are a sufficient number of nearby base stations on the same frequency for the UE 202 to measure, usually at least three, then the UE 202 simply performs intra-frequency measurements.

Note that it is possible that, for a given inter-frequency positioning measurement, there may not be a CA receiver chain configuration supported by the UE 202. For example, this can occur when the received assistance data includes information for a greater number of inert-frequency bands than there are UE-supported CA receiver chain configurations (e.g., if the UE 202 has only two carrier aggregation receiver chains, but the received assistance data includes information for seven inter-frequency bands). As another example, this can also occur when the received assistance data includes inter-frequency bands that are not supported by the UE's 202 CA receiver chains. As yet another example, this can also occur when the UE 202 is already in CA mode for data activity and the received assistance data includes non-overlapped inter-frequency bands. When the UE 202 does not have a CA receiver chain configuration for one or more of the received inter-frequency bands for the reasons above, it can use MG mode to perform inter-frequency measurements in those bands on the primary receiver chain or one or more supported available carrier aggregation receiver chains. When the UE 202 does not have a CA receiver chain configuration for any of the received inter-frequency bands, it can use MG mode for all inter-frequency positioning measurements. As such, it is understood that the UE 202 may also determine, after 710 but before 714, whether or not it supports a CA receiver chain configuration for the given inter-frequency positioning measurement. As such, even if a CA mode is supported, UE 202 moves to 712 instead of 714, and the UE 202 utilizes measurement gaps to perform the IF-OTDOA measurements.

Referring back to 710, if the UE 202 supports a CA mode and CA would benefit from IF-OTDOA measurements, then at 714, the UE 202 determines whether or not CA is already being used for a data session (e.g., a high-speed data download). If it is, then at 716, the UE 202 determines whether or not additional CA receivers would be beneficial to perform the IF-OTDOA measurements on the number of frequency bands indicated in the assistance data received from the location server 170 at 708. If additional CA receivers would be beneficial, or CA is not already being used for a data session, then at 718, the UE 202 enables the number of CA receivers that would be beneficial to perform the IF-OTDOA measurements. Note that if the number of CA receivers available on the UE 202 (e.g., 2DLCA) is less than the number of frequency bands (e.g., four) in the received assistance data to be searched/measured, then the UE 202 utilizes measurement gaps to measure the remaining (e.g., two) frequency bands. In such cases, if the UE 202 is already performing a CA-based download (e.g., a high-speed data download), or multiple CA-based downloads, the UE 202 can select the receiver chain(s) that is/are handling the lowest data rate download(s) to perform IF-OTDOA measurements. The UE 202 may preferentially avoid using the primary receiver chain for performing IF-OTDOA measurements so that it can continue receiving the CA-based download(s).

More specifically, the primary receiver chain may be configured to perform inter-frequency measurements on other frequencies using measurement gaps. For example, if the UE 202 determines to use only the measurement gap method to perform inter-frequency measurements, then the UE 202 will send a request for measurement gaps to the serving cell and will tune the primary receiver chain to one inter-frequency and perform PRS/RSTD measurements on that frequency. Similarly, for the second inter-frequency band, the UE 202 will again request new measurement gaps and perform RSTD measurements. In this manner, the UE 202 can perform inter-frequency measurements for all the inter-frequency bands without using CA-receivers.

To perform measurements on any additional frequencies, the UE 202 would need to employ additional (secondary) receiver chains, one receiver chain per frequency, as only the primary receiver chain may be able to use measurement gaps (although the secondary receiver chains of certain UE's may also be able utilize measurement gaps). Alternatively, the UE 202 may utilize the primary receiver chain to measure one frequency and one or more secondary receiver chains to measure additional frequencies. Thus, for example, if the assistance data included information about base stations on four different frequencies but only the primary receiver chain is currently enabled, the UE 202 will need to enable two or three additional receiver chains, if available, to measure the remaining two or three frequencies (depending on whether the primary receiver chain uses measurement gaps).

More generally, the UE 202 can determine whether or not a carrier aggregation receiver chain can support at least one of the plurality of inter-frequency positioning measurements indicated in the positioning assistance data. Based on the carrier aggregation receiver chain being able to support at least one of the plurality of inter-frequency positioning measurements, the UE 202 can determine whether or not the carrier aggregation receiver chain is currently being used for a data session. Based on the carrier aggregation receiver chain being currently used for the data session, the UE 202 can determine whether or not to enable at least one additional carrier aggregation receiver chain for the plurality of inter-frequency positioning measurements. Alternatively, based on the carrier aggregation receiver chain not being currently used for the data session or the at least one additional carrier aggregation receiver chain not being enabled for the plurality of inter-frequency positioning measurements, the UE 202 can enable the at least one additional carrier aggregation receiver.

As a specific example, if the UE 202 has three CA receiver chains (e.g., 3DLCA) and is currently engaged in a data session utilizing two receiver chains (e.g., 2DLCA) and the assistance data includes only one inter frequency band, then the UE 202 can enable (i.e., turn on) the unused CA receiver chain to perform the IF-OTDOA measurements. Because the UE 202 uses a receiver chain that is not being utilized for the data session to perform the IF-OTDOA measurements, the data throughput of the data session will not be impacted.

As another specific example, if the UE 202 has three CA receiver chains (e.g., 3DLCA) and is currently engaged in a data session utilizing all three receiver chains and the assistance data includes four IF-OTDOA bands, then the UE 202 can assign one frequency band to each CA receiver chain. The CA receiver chain with the lowest data rate of the data session can then utilize measurement gaps to measure the fourth frequency band, rather than require the primary receiver chain to use measurement gaps. This minimizes the impact on the throughput of the data session to the UE 202.

As yet another specific example, if the UE 202 has three CA receiver chains (e.g., 3DLCA) and is currently engaged in a data session utilizing two receiver chains (e.g., 2DLCA) and the assistance data includes five IF-OTDOA bands, then the UE 202 can check whether the CA receivers are already engaged in the same frequency bands as the IF-OTDOA bands. If they are, then the UE 202 can use the already engaged CA receiver chains for positioning measurements on those frequency bands. If the frequency bands are not overlapping, then unused CA receiver chains can be used to measure all frequency bands.

Thus, as illustrated in the foregoing examples, the carrier aggregation receiver chain configuration maximizes the number of the plurality of inter-frequency positioning measurements indicated in the positioning assistance data that can be performed by one or more carrier aggregation receiver chains of the UE 202.

At 720, whether the UE 202 performed legacy OTDOA using measurement gaps (712), determined that no additional CA receiver chains are to be enabled (716), or enabled the additional CA receiver chains (718), the UE 202 reports the measured OTDOAs/RSTDs to the location server 170. In particular, if the UE 202 performed inter-frequency positioning measurements, the UE 202 sends the plurality of inter-frequency positioning measurements to the location server 170. At 722, the flow 700 ends. Alternatively or additionally, it is understood that the UE 202 may use the plurality of inter-frequency positioning measurements to compute its own position with or without reporting to the location server 170.

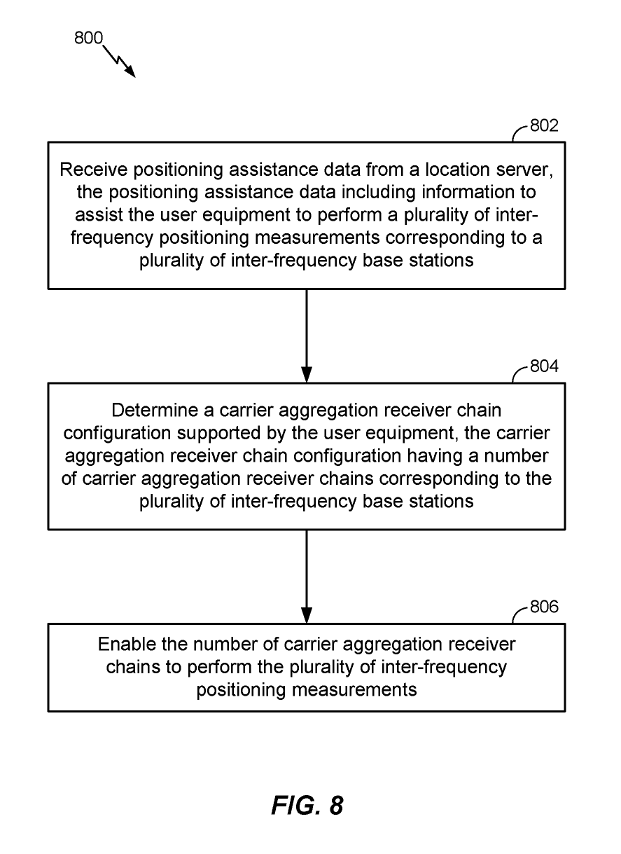

FIG. 8 illustrates an exemplary flow 800 for enabling carrier aggregation receivers of a user equipment, such as UE 202. At 802, the UE 202, e.g., the CA enablement module 334 in conjunction with the baseband modem processor 316 and the RF resource 318, receives positioning assistance data from a location server, such as location server 170. The positioning assistance data may include information to assist the UE 202 to perform a plurality of inter-frequency positioning measurements (e.g., IF-OTDOA measurements) corresponding to a plurality of inter-frequency base stations, such as first base station 220 and second base station 222 of FIGS. 2A and 2B. At 804, the UE 202, e.g., the CA enablement module 334, determines a carrier aggregation receiver chain configuration supported by the UE 202. The carrier aggregation receiver chain configuration may have a number of carrier aggregation receiver chains corresponding to the plurality of inter-frequency base stations. At 806, the UE 202, e.g., the CA enablement module 334, enables the number of carrier aggregation receiver chains to perform the plurality of inter-frequency positioning measurements.

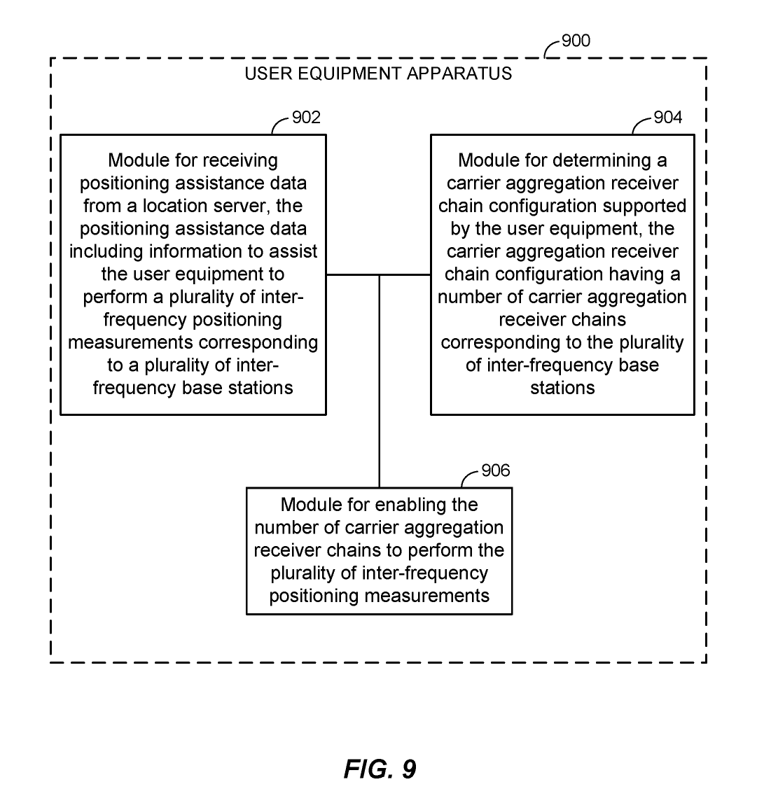

FIG. 9 illustrates an example user equipment apparatus 900 represented as a series of interrelated functional modules. A module for receiving 902 may correspond at least in some aspects to, for example, a communication device, such as the CA enablement module 334 in conjunction with the baseband modem processor 316 and the RF resource 318, as discussed herein. A module for determining 904 may correspond at least in some aspects to, for example, a processing system, such as the processor 306 in conjunction with the CA enablement module 334, as discussed herein. A module for enabling 906 may correspond at least in some aspects to, for example, a processing system, such as the processor 306 in conjunction with the CA enablement module 334, as discussed herein.

The functionality of the modules of FIG. 9 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 9, as well as other components and functions described herein, may be implemented using any suitable means. Such means also may be implemented, at least in part, using corresponding structure as taught herein. For example, the components described above in conjunction with the “module for” components of FIG. 9 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM) memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both non-transitory computer-readable storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

For example, in an aspect, a computer-readable medium may store computer-executable instructions for enabling carrier aggregation receivers of a UE, such as UE 202. The computer-executable instructions may include instructions instructing the UE (or one or more processors or one or more devices within the UE) to perform the method illustrated in FIG. 7. For example, the computer-executable instructions may include at least one instruction instructing a UE to process positioning assistance data from a location server, the positioning assistance data including information to assist the UE to perform a plurality of inter-frequency positioning measurements corresponding to a plurality of inter-frequency base stations, at least one instruction instructing the UE to determine a carrier aggregation receiver chain configuration supported by the UE, the carrier aggregation receiver chain configuration having a number of carrier aggregation receiver chains corresponding to the plurality of inter-frequency base stations, and at least one instruction for the UE to enable the number of carrier aggregation receiver chains to perform the plurality of inter-frequency positioning measurements.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method for enabling carrier aggregation receivers of a user equipment, comprising:
receiving, at the user equipment, positioning assistance data from a location server, the positioning assistance data including information to assist the user equipment to perform a plurality of inter-frequency positioning measurements corresponding to a plurality of inter-frequency base stations;
determining, by the user equipment, a carrier aggregation receiver chain configuration supported by the user equipment, the carrier aggregation receiver chain configuration having a number of carrier aggregation receiver chains currently not being used for a data session; and
enabling, by the user equipment, the number of carrier aggregation receiver chains currently not being used for the data session of the carrier aggregation receiver chain configuration to perform at least some of the plurality of inter-frequency positioning measurements without the use of measurement gaps.

2. The method of claim 1, wherein the determining comprises:
determining, by the user equipment, whether or not a carrier aggregation receiver chain of the user equipment can support at least one of the plurality of inter-frequency positioning measurements indicated in the positioning assistance data; and
based on the carrier aggregation receiver chain of the user equipment being able to support at least one of the plurality of inter-frequency positioning measurements, determining, by the user equipment, whether or not the carrier aggregation receiver chain is currently being used for the data session.

3. The method of claim 2, further comprising:
based on the carrier aggregation receiver chain being currently used for the data session, determining, by the user equipment, whether or not to enable at least one additional carrier aggregation receiver chain for the plurality of inter-frequency positioning measurements; and
based on the carrier aggregation receiver chain not being currently used for the data session or the at least one additional carrier aggregation receiver chain not being enabled for the plurality of inter-frequency positioning measurements, enabling, by the user equipment, the at least one additional carrier aggregation receiver chain.

4. The method of claim 1, wherein the carrier aggregation receiver chain configuration maximizes a number of the plurality of inter-frequency positioning measurements indicated in the positioning assistance data that can be performed by one or more carrier aggregation receiver chains of the user equipment.

5. The method of claim 1, further comprising:
performing, by the user equipment, the at least some of the plurality of inter-frequency positioning measurements based on the positioning assistance data;
performing, responsive to a determination that remaining inter-frequency positioning measurements of the plurality of inter-frequency positioning measurements not supported by the carrier aggregation receiver chains of the carrier aggregation receiver chain configuration exist, inter-frequency positioning measurements for the remaining inter-frequency positioning measurements of the plurality of inter-frequency positioning measurements not supported by the carrier aggregation receiver chains of the carrier aggregation receiver chain configuration during one or more measurement gaps; and
sending, by the user equipment, the plurality of inter-frequency positioning measurements to the location server.

6. The method of claim 1, wherein the determining is based on a deployment of a plurality of inter-frequency base stations at a location of the user equipment as defined in the positioning assistance data.

7. The method of claim 1, further comprising:
receiving, at the user equipment, a location request; and
deactivating, by the user equipment, the number of carrier aggregation receiver chains currently not being used for the data session of the user equipment after responding to the location request with the at least some of the plurality of inter-frequency positioning measurements.

8. The method of claim 7, wherein the location request is received from an application resident on the user equipment.

9. The method of claim 7, wherein the location request is received from the location server in response to the user equipment initiating an emergency call.

10. The method of claim 1, wherein the determining is based on the positioning assistance data from the location server.

11. An apparatus for enabling carrier aggregation receivers of a user equipment, comprising:
a transceiver configured to receive positioning assistance data from a location server, the positioning assistance data including information to assist the user equipment to perform a plurality of inter-frequency positioning measurements corresponding to a plurality of inter-frequency base stations; and
at least one processor configured to:
determine a carrier aggregation receiver chain configuration supported by the user equipment, the carrier aggregation receiver chain configuration having a number of carrier aggregation receiver chains currently not being used for a data session; and
enable the number of carrier aggregation receiver chains currently not being used for the data session of the carrier aggregation receiver chain configuration to perform at least some of the plurality of inter-frequency positioning measurements without the use of measurement gaps.

12. The apparatus of claim 11, wherein the at least one processor being configured to determine comprises the at least one processor configured to:
determine whether or not a carrier aggregation receiver chain of the user equipment can support at least one of the plurality of inter-frequency positioning measurements indicated in the positioning assistance data; and
determine, based on the carrier aggregation receiver chain of the user equipment being able to support at least one of the plurality of inter-frequency positioning measurements, whether or not the carrier aggregation receiver chain is currently being used for the data session.

13. The apparatus of claim 12, wherein the at least one processor is further configured to:
determine, based on the carrier aggregation receiver chain being currently used for the data session, whether or not to enable at least one additional carrier aggregation receiver chain for the plurality of inter-frequency positioning measurements; and
enable, based on the carrier aggregation receiver chain not being currently used for the data session or the at least one additional carrier aggregation receiver chain not being enabled for the plurality of inter-frequency positioning measurements, the at least one additional carrier aggregation receiver chain.

14. The apparatus of claim 11, wherein the carrier aggregation receiver chain configuration maximizes a number of the plurality of inter-frequency positioning measurements indicated in the positioning assistance data that can be performed by one or more carrier aggregation receiver chains of the user equipment.

15. The apparatus of claim 11, wherein the at least one processor is further configured to instruct the apparatus to
perform the at least some of the plurality of inter-frequency positioning measurements based on the positioning assistance data, and
perform, responsive to a determination that remaining inter-frequency positioning measurements of the plurality of inter-frequency positioning measurements not supported by the carrier aggregation receiver chains of the carrier aggregation receiver chain configuration exist, inter-frequency positioning measurements for the remaining inter-frequency positioning measurements of the plurality of inter-frequency positioning measurements not supported by the carrier aggregation receiver chains of the carrier aggregation receiver chain configuration during one or more measurement gaps,
wherein the transceiver is further configured to send the plurality of inter-frequency positioning measurements to the location server.

16. The apparatus of claim 11, wherein the at least one processor being configured to determine comprises the at least one processor being configured to determine the carrier aggregation receiver chain configuration supported by the user equipment based on a deployment of the plurality of inter-frequency base stations capable of supporting positioning of the user equipment at a location of the user equipment as defined in the positioning assistance data.

17. The apparatus of claim 11, wherein the at least one processor is further configured to:
receive a location request; and
deactivate the number of carrier aggregation receiver chains currently not being used for the data session of the user equipment after the user equipment responds to the location request with the at least some of the plurality of inter-frequency positioning measurements.

18. The apparatus of claim 17, wherein the location request is received from an application resident on the user equipment.

19. The apparatus of claim 17, wherein the location request is received from the location server in response to initiation by the user equipment of an emergency call.

20. The apparatus of claim 11, wherein the at least one processor being configured to determine comprises the at least one processor being configured to determine the carrier aggregation receiver chain configuration supported by the user equipment based on the positioning assistance data from the location server.

21. A non-transitory computer-readable medium storing computer-executable instructions for enabling carrier aggregation receivers of a user equipment, the computer-executable instructions comprising:
at least one instruction instructing a user equipment to process positioning assistance data from a location server, the positioning assistance data including information to assist the user equipment to perform a plurality of inter-frequency positioning measurements corresponding to a plurality of inter-frequency base stations;
at least one instruction instructing the user equipment to determine a carrier aggregation receiver chain configuration supported by the user equipment, the carrier aggregation receiver chain configuration having a number of carrier aggregation receiver chains currently not being used for a data session; and
at least one instruction instructing the user equipment to enable the number of carrier aggregation receiver chains currently not being used for the data session of the carrier aggregation receiver chain configuration to perform at least some of the plurality of inter-frequency positioning measurements without the use of measurement gaps.

22. The non-transitory computer-readable medium of claim 21, wherein the at least one instruction instructing the user equipment to determine the carrier aggregation receiver chain configuration supported by the user equipment comprises:
at least one instruction instructing the user equipment to determine whether or not a carrier aggregation receiver chain of the user equipment can support at least one of the plurality of inter-frequency positioning measurements indicated in the positioning assistance data; and
at least one instruction instructing the user equipment to determine, based on the carrier aggregation receiver chain of the user equipment being able to support at least one of the plurality of inter-frequency positioning measurements, whether or not the carrier aggregation receiver chain is currently being used for the data session.

23. The non-transitory computer-readable medium of claim 22, further comprising:
at least one instruction instructing the user equipment to determine, based on the carrier aggregation receiver chain being currently used for the data session, whether or not to enable at least one additional carrier aggregation receiver chain for the plurality of inter-frequency positioning measurements; and
at least one instruction instructing the user equipment to enable, based on the carrier aggregation receiver chain not being currently used for the data session or the at least one additional carrier aggregation receiver chain not being enabled for the plurality of inter-frequency positioning measurements, the at least one additional carrier aggregation receiver chain.

24. The non-transitory computer-readable medium of claim 21, wherein the carrier aggregation receiver chain configuration maximizes a number of the plurality of inter-frequency positioning measurements indicated in the positioning assistance data that can be performed by one or more carrier aggregation receiver chains of the user equipment.

25. The non-transitory computer-readable medium of claim 21, further comprising:
at least one instruction instructing the user equipment to perform the at least some of the plurality of inter-frequency positioning measurements based on the positioning assistance data;
at least one instruction instructing the user equipment to perform, responsive to a determination that remaining inter-frequency positioning measurements of the plurality of inter-frequency positioning measurements not supported by the carrier aggregation receiver chains of the carrier aggregation receiver chain configuration exist, inter-frequency positioning measurements for the remaining inter-frequency positioning measurements of the plurality of inter-frequency positioning measurements not supported by the carrier aggregation receiver chains of the carrier aggregation receiver chain configuration during one or more measurement gaps; and
at least one instruction instructing the user equipment to send the plurality of inter-frequency positioning measurements to the location server.

26. The non-transitory computer-readable medium of claim 21, wherein the determination is based on a deployment of a plurality of inter-frequency base stations at a location of the user equipment as defined in the positioning assistance data.

27. The non-transitory computer-readable medium of claim 21, further comprising:
at least one instruction instructing the user equipment to receive a location request; and
at least one instruction instructing the user equipment to deactivate the number of carrier aggregation receiver chains currently not being used for the data session of the user equipment after the user equipment responds to the location request with the at least some of the plurality of inter-frequency positioning measurements.

28. The non-transitory computer-readable medium of claim 27, wherein the location request is received from an application resident on the user equipment.

29. The non-transitory computer-readable medium of claim 21, wherein the location request is received from the location server in response to initiation by the user equipment of an emergency call.

30. An apparatus for enabling carrier aggregation receivers of a user equipment, comprising:
means for receiving positioning assistance data from a location server, the positioning assistance data including information to assist the user equipment to perform a plurality of inter-frequency positioning measurements corresponding to a plurality of inter-frequency base stations;
means for determining a carrier aggregation receiver chain configuration supported by the user equipment, the carrier aggregation receiver chain configuration having a number of carrier aggregation receiver chains currently not being used for a data session; and
means for enabling the number of carrier aggregation receiver chains currently not being used for the data session of the carrier aggregation receiver chain configuration to perform at least some of the plurality of inter-frequency positioning measurements without the use of measurement gaps.
